(19) United States
(12) Patent Application Publication
(10) Pub. No.: US 2023/0041868 A1
(43) Pub. Date: Feb. 9, 2023

(54) CONTROL APPARATUS, SYSTEM, VEHICLE, AND CONTROL METHOD

(71) Applicant: TOYOTA JIDOSHA KABUSHIKI KAISHA, Toyota-shi, Aichi-ken (JP)

(72) Inventors: Toyokazu NAKASHIMA, Nagoya-shi (JP); Takeshi TAKEMOTO, Nagoya-shi (JP); Naoko YAMAFUJI, Nagoya-shi (JP); Naoya OKA, Nagakute-shi (JP)

(73) Assignee: TOYOTA JIDOSHA KABUSHIKI KAISHA, Toyota-shi (JP)

(21) Appl. No.: 17/812,218

(22) Filed: Jul. 13, 2022

(30) Foreign Application Priority Data
Jul. 30, 2021 (JP) 2021-126217

(51) Int. Cl. G06F 21/62; G07C 5/04; G07C 5/00; G07C 5/08

(52) U.S. Cl. CPC G06F 21/6218; G07C 5/04; G07C 5/008; G07C 5/0825

(57) ABSTRACT

A control apparatus includes a controller configured to select, depending on a type of vehicle data obtained by monitoring a state of a vehicle, a driver or an owner of the vehicle as an authorized party who grants permission to provide the vehicle data to a third party other than the driver and the owner, and notify the selected authorized party of information prompting for the permission.

### CROSS-REFERENCE TO RELATED APPLICATION

This application claims priority to Japanese Patent Application No. 2021-126217 filed on Jul. 30, 2021, the entire contents of which are incorporated herein by reference.

### TECHNICAL FIELD

The present disclosure relates to a control apparatus, a system, a vehicle, and a control method.

### BACKGROUND

Patent literature (PTL) 1 discloses technology related to a procedure for obtaining consent from a user when providing personal data of the user to a third party.

### Citation List

### Patent Literature

PTL 1: JP 2020-024511 A

### SUMMARY

When vehicle data obtained by monitoring a state of a vehicle is to be provided to a third party, an authorized party who has authority to grant permission to provide the vehicle data may differ depending on the type of vehicle data. With the technology described in PTL 1, in a case in which a user who has permitted the provision of vehicle data does not have the authority, the vehicle data cannot be provided to a third party, and the data cannot be used effectively.

It would be helpful to facilitate the effective use of vehicle data.

A control apparatus according to the present disclosure includes a controller configured to:
select, depending on a type of vehicle data obtained by monitoring a state of a vehicle, a driver or an owner of the vehicle as an authorized party who grants permission to provide the vehicle data to a third party other than the driver and the owner; and
notify the selected authorized party of information prompting for the permission.

A control method according to the present disclosure includes:
selecting, by a control apparatus, depending on a type of vehicle data obtained by monitoring a state of a vehicle, a driver or an owner of the vehicle as an authorized party who grants permission to provide the vehicle data to a third party other than the driver and the owner; and
notifying, by the control apparatus, the selected authorized party of information prompting for the permission.

According to the present disclosure, the effective use of vehicle data is facilitated.

### BRIEF DESCRIPTION OF THE DRAWINGS

In the accompanying drawings:

FIG. 1 is a block diagram illustrating a configuration of a system according to an embodiment of the present disclosure;

FIG. 2 is a block diagram illustrating a configuration of a control apparatus according to the embodiment of the present disclosure;

FIG. 3 is a block diagram illustrating a configuration of a first terminal apparatus according to the embodiment of the present disclosure;

FIG. 4 is a block diagram illustrating a configuration of a second terminal apparatus according to the embodiment of the present disclosure;

FIG. 5 is a flowchart illustrating operations of the control apparatus according to the embodiment of the present disclosure; and

FIG. 6 is a schematic diagram illustrating an example screen of a first terminal apparatus or of a second terminal apparatus according to the embodiment of the present disclosure.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

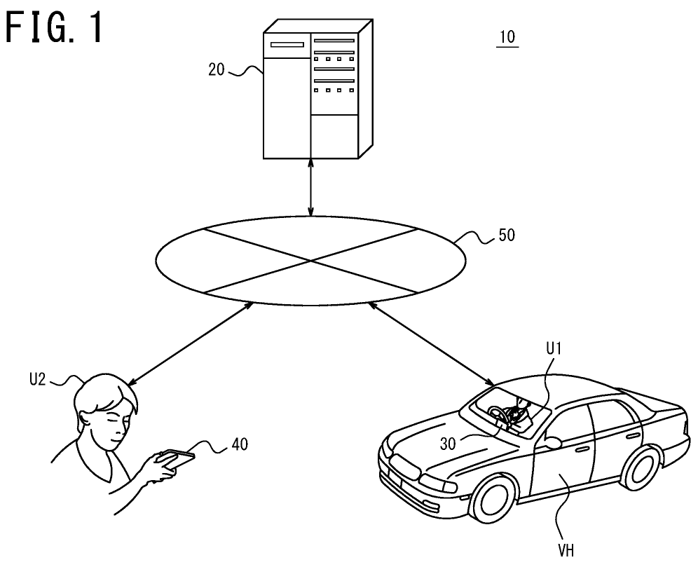

A configuration of a system 10 according to the present embodiment will be described with reference to FIG. 1.

The system 10 according to the present embodiment includes a control apparatus 20, at least one first terminal apparatus 30, and at least one second terminal apparatus 40. The control apparatus 20 can communicate with the first terminal apparatus 30 and the second terminal apparatus 40 via a network 50.

The control apparatus 20 is installed in a facility such as a data center. The control apparatus 20 is a computer such as a server that belongs to a cloud computing system or another type of computing system.

The first terminal apparatus 30 is used by a driver U1 of a vehicle VH. The second terminal apparatus 40 is used by an owner U2 of the vehicle VH. The first terminal apparatus 30 and the second terminal apparatus 40 are each a mobile device such as a mobile phone, a smartphone, or a tablet.

The vehicle VH is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle VH is driven by the driver U1 in the present embodiment, but the driving may be automated at any level. The automation level is, for example, any one of Level 1 to Level 5 according to the level classification defined by SAE. The name “SAE” is an abbreviation of Society of Automotive Engineers. The vehicle VH may be a MaaS-dedicated vehicle. The term “MaaS” is an abbreviation of Mobility as a Service.

The network 50 includes the Internet, at least one WAN, at least one MAN, or any combination thereof. The term “WAN” is an abbreviation of wide area network. The term “MAN” is an abbreviation of metropolitan area network. The network 50 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

In the present embodiment, data obtained by monitoring the state of the vehicle VH is acquired as vehicle data VD. The acquired vehicle data VD is stored on a cloud server, for example, and provided to a third party, which is a potential buyer, in cases such as when the vehicle VH is to be bought or sold. In view of protecting personal information, permission from the driver U1 or the owner U2 of the vehicle VH is required to provide the vehicle data VD to a third party. In particular, when the owner U2 of the vehicle VH is different from the driver U1 who drives the vehicle VH, the person authorized to grant the permission may differ depending on the type of vehicle data VD, even for vehicle data VD obtained on the same vehicle VH. For example, the provision of vehicle data VD obtained during movement of the vehicle VH may require the permission of the driver U1 of the vehicle VH, whereas the provision of vehicle data VD obtained during a period other than during movement of the vehicle VH may require the permission of the owner U2 of the vehicle VH. Specific examples of a case in which the owner U2 and the driver U1 of the vehicle VH differ are as follows. For example, a case can be envisioned in which an operator of a service such as a car rental service or car sharing service owns the vehicle VH as the owner U2 while a user of the service drives the vehicle VH as the driver U1. Another case can be envisioned in which the vehicle VH is owned by a husband as the owner U2, but is driven by a wife as the driver U1.

In the system 10 according to the present embodiment, the control apparatus 20 selects, depending on the type of vehicle data VD obtained by monitoring a state of the vehicle VH, the driver U1 or the owner U2 of the vehicle VH as an authorized party who grants permission to provide the vehicle data VD to a third party other than the driver U1 and the owner U2. The control apparatus 20 notifies the selected authorized party of information prompting for the permission.

The present embodiment enables to select, in a case in which the authorized party who grants permission to provide the vehicle data VD to a third party differs depending on the type of vehicle data VD, the authorized party according to the type of vehicle data VD, and to acquire permission from the authorized party. Thus, a situation is likely to be avoided in which the person who has permitted the provision of the vehicle data VD is not an authorized party and thus the vehicle data VD cannot be provided to a third party. Therefore, the effective use of the vehicle data VD may be facilitated.

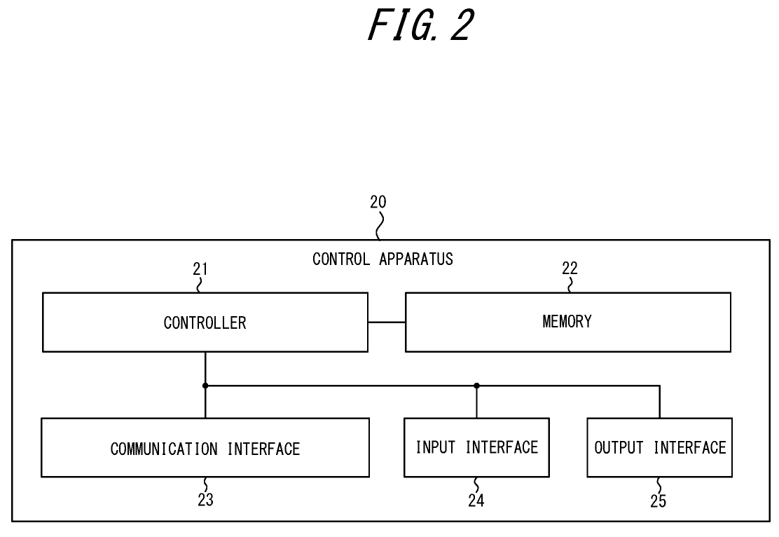

A configuration of the control apparatus 20 according to the present embodiment will be described with reference to FIG. 2.

The control apparatus 20 includes a controller 21, a memory 22, a communication interface 23, an input interface 24, and an output interface 25.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or any combination thereof. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20. In the present embodiment, the vehicle data VD may be stored in the memory 22.

The communication interface 23 includes at least one interface for communication. The interface for communication is, for example, a LAN interface. The communication interface 23 receives data to be used for the operations of the control apparatus 20, and transmits data obtained by the operations of the control apparatus 20. In the present embodiment, the communication interface 23 communicates with the first terminal apparatus 30 and the second terminal apparatus 40.

The input interface 24 includes at least one interface for input. The interface for input is, for example, a physical key, a capacitive key, a pointing device, a touchscreen integrally provided with a display, or a microphone. The input interface 24 accepts an operation for inputting data to be used for the operations of the control apparatus 20. The input interface 24, instead of being included in the control apparatus 20, may be connected to the control apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the control apparatus 20. The output interface 25, instead of being included in the control apparatus 20, may be connected to the control apparatus 20 as an external output device. As the connection method, any technology such as USB, HDMI®, or Bluetooth®can be used.

The functions of the control apparatus 20 are realized by execution of a control program according to the present embodiment by a processor serving as the controller 21. That is, the functions of the control apparatus 20 are realized by software. The control program causes a computer to execute the operations of the control apparatus 20, thereby causing the computer to function as the control apparatus 20. That is, the computer executes the operations of the control apparatus 20 in accordance with the control program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a programmable circuit or a dedicated circuit serving as the controller 21. That is, some or all of the functions of the control apparatus 20 may be realized by hardware.

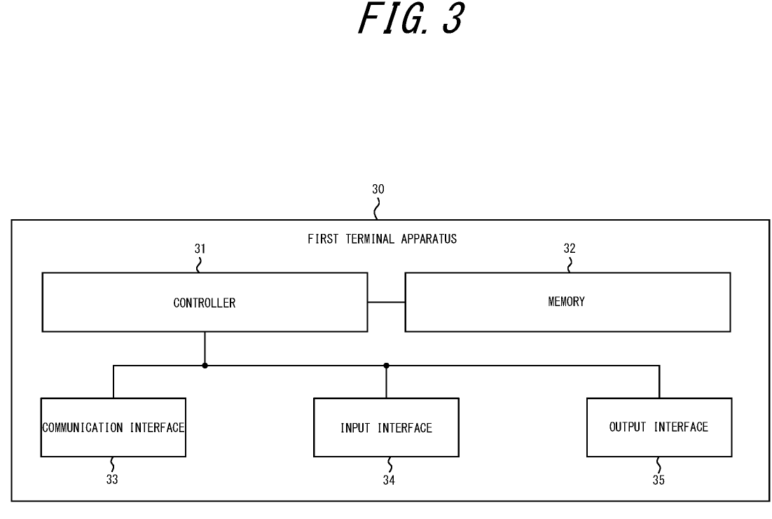

A configuration of the first terminal apparatus 30 according to the present embodiment will be described with reference to FIG. 3.

The first terminal apparatus 30 includes a controller 31, a memory 32, a communication interface 33, an input interface 34, and an output interface 35.

The controller 31 includes at least one processor, at least one programmable circuit, at least one dedicated circuit, or a combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 31 executes processes related to operations of the first terminal apparatus 30 while controlling components of the first terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores data to be used for the operations of the first terminal apparatus 30 and data obtained by the operations of the first terminal apparatus 30.

The communication interface 33 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives data to be used for the operations of the first terminal apparatus 30, and transmits data obtained by the operations of the first terminal apparatus 30.

The input interface 34 includes at least one interface for input. The interface for input is, for example, a physical key, a capacitive key, a pointing device, a touchscreen integrally provided with a display, or a microphone. The input interface 34 accepts an operation for inputting data to be used for the operations of the first terminal apparatus 30. The input interface 34, instead of being included in the first terminal apparatus 30, may be connected to the first terminal apparatus 30 as an external input device. As the connection method, any technology such as USB, HDMI®, or Bluetooth® can be used.

The output interface 35 includes at least one interface for output. The interface for output is, for example, a display or a speaker. The display is, for example, an LCD or an organic EL display. The output interface 35 outputs data obtained by the operations of the first terminal apparatus 30. The output interface 35, instead of being included in the first terminal apparatus 30, may be connected to the first terminal apparatus 30 as an external output device. As the connection method, any technology such as USB, HDMI^{®}, or Bluetooth^{®} can be used.

The functions of the first terminal apparatus 30 are realized by execution of a first terminal program according to the present embodiment by a processor serving as the controller 31. That is, the functions of the first terminal apparatus 30 are realized by software. The first terminal program causes a computer to execute the operations of the first terminal apparatus 30, thereby causing the computer to function as the first terminal apparatus 30. That is, the computer executes the operations of the first terminal apparatus 30 in accordance with the first terminal program to thereby function as the first terminal apparatus 30.

Some or all of the functions of the first terminal apparatus 30 may be realized by a programmable circuit or a dedicated circuit serving as the controller 31. That is, some or all of the functions of the first terminal apparatus 30 may be realized by hardware.

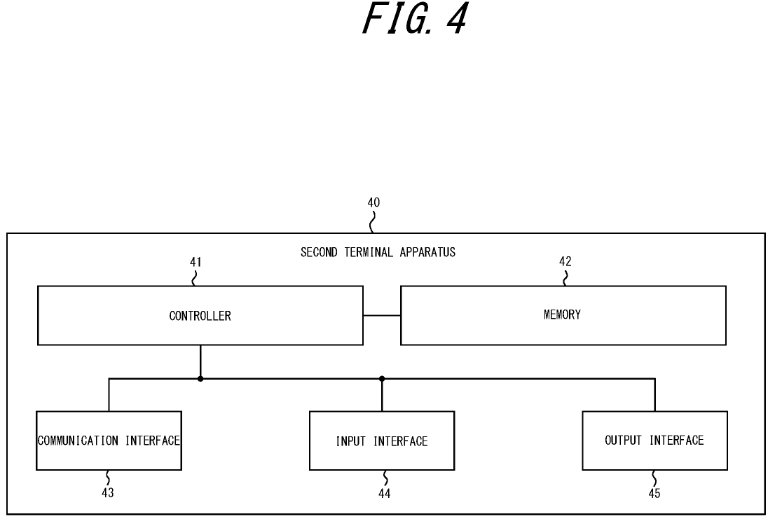

A configuration of the second terminal apparatus 40 according to the present embodiment will be described with reference to FIG. 4.

The second terminal apparatus 40 includes a controller 41, a memory 42, a communication interface 43, an input interface 44, and an output interface 45.

The controller 41 includes at least one processor, at least one programmable circuit, at least one dedicated circuit, or a combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 41 executes processes related to operations of the second terminal apparatus 40 while controlling components of the second terminal apparatus 40.

The memory 42 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores data to be used for the operations of the second terminal apparatus 40 and data obtained by the operations of the second terminal apparatus 40.

The communication interface 43 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The communication interface 43 receives data to be used for the operations of the second terminal apparatus 40, and transmits data obtained by the operations of the second terminal apparatus 40.

The input interface 44 includes at least one interface for input. The interface for input is, for example, a physical key, a capacitive key, a pointing device, a touchscreen integrally provided with a display, or a microphone. The input interface 44 accepts an operation for inputting data to be used for the operations of the second terminal apparatus 40. The input interface 44, instead of being included in the second terminal apparatus 40, may be connected to the second terminal apparatus 40 as an external input device. As the connection method, any technology such as USB, HDMI^{®}, or Bluetooth^{®} can be used.

The output interface 45 includes at least one interface for output. The interface for output is, for example, a display or a speaker. The display is, for example, an LCD or an organic EL display. The output interface 45 outputs data obtained by the operations of the second terminal apparatus 40. The output interface 45, instead of being included in the second terminal apparatus 40, may be connected to the second terminal apparatus 40 as an external output device. As the connection method, any technology such as USB, HDMI®, or Bluetooth® can be used.

The functions of the second terminal apparatus 40 are realized by execution of a second terminal program according to the present embodiment by a processor serving as the controller 41. That is, the functions of the second terminal apparatus 40 are realized by software. The second terminal program causes a computer to execute the operations of the second terminal apparatus 40, thereby causing the computer to function as the second terminal apparatus 40. That is, the computer executes the operations of the second terminal apparatus 40 in accordance with the second terminal program to thereby function as the second terminal apparatus 40.

Some or all of the functions of the second terminal apparatus 40 may be realized by a programmable circuit or a dedicated circuit serving as the controller 41. That is, some or all of the functions of the second terminal apparatus 40 may be realized by hardware.

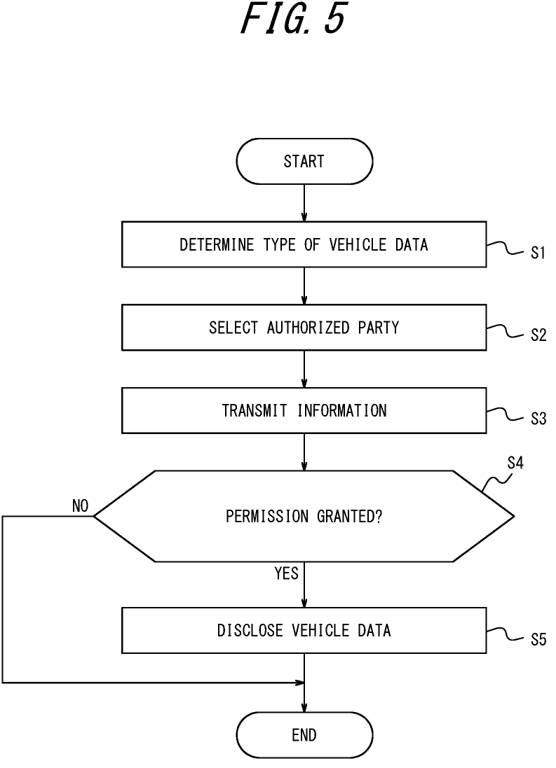

Operations of the system 10 according to the present embodiment will be described with reference to FIG. 5. These operations correspond to a control method according to the present embodiment.

In step S1, the controller 21 of the control apparatus 20 determines the type of vehicle data VD obtained by monitoring the state of the vehicle VH. The vehicle data VD may be acquired by any appropriate procedure, such as the following procedure. The vehicle data VD is acquired by an in-vehicle communication device, which communicates via a CAN with various ECUs mounted in the vehicle VH, and is uploaded from the in-vehicle communication device and stored on a cloud server. The term “ECU” is an abbreviation of Electronic Control Unit. The term “CAN” is an abbreviation of Controller Area Network. The controller 21 of the control apparatus 20 communicates with a cloud server via the communication interface 23, and acquires the vehicle data VD stored on the cloud server. The vehicle data VD may instead be stored in the memory 22 of the control apparatus 20. That is, the controller 21 of the control apparatus 20 may acquire the vehicle data VD stored in the memory 22.

The controller 21 of the control apparatus 20 determines the type of the acquired vehicle data VD. In the present embodiment, the types of vehicle data VD include first vehicle data VD1 obtained during movement of the vehicle VH and second vehicle data VD2 obtained during a period other than during movement of the vehicle VH.

The first vehicle data VD1 is data obtained by recording values that vary along the travel of the vehicle VH. The first vehicle data VD1 includes, for example, data indicating a collision history, a usage history, or a travel distance of the vehicle VH. The collision history is a record of collisions of the vehicle VH with any object, such as an obstacle. A collision of the vehicle VH may be detected by any procedure, such as by a collision detection sensor mounted in the vehicle VH. A collision detection sensor is a type of ECU. The collision of the vehicle VH may be detected based on a signal from a vibration sensor mounted in the vehicle VH. A vibration sensor is a type of ECU. Alternatively, a collision of the vehicle VH may be detected by analysis of images captured by an in-vehicle imaging apparatus, such as a drive recorder, mounted in the vehicle VH. The in-vehicle imaging apparatus is a type of ECU. The usage history is a record of the usage conditions of the vehicle VH. For example, fuel consumption values calculated based on the travel history of the vehicle VH, the average number of driving days per unit period, or the average travel distance per unit travel are recorded as the usage history. The travel distance is acquired from, for example, an odometer mounted in the vehicle VH. Alternatively, the travel distance may be calculated based on, for example, the travel history of the vehicle VH. The controller 21 of the control apparatus 20 may determine that an odometer mounted in the vehicle VH has been rewound in a case in which the difference between the travel distance calculated based on the travel history of the vehicle VH and the travel distance acquired from the odometer is equal to or greater than a threshold.

The second vehicle data VD2 is data related to the conditions of components or systems to determine the impact on the use of the vehicle VH. Specifically, the second vehicle data VD2 is data that indicates the operating state of the engine, motor system, transmission, brakes, battery, and the like of the vehicle VH. The second vehicle data VD2 includes data indicating a maintenance history of the vehicle VH or data for failure diagnosis of the vehicle VH. The maintenance history of the vehicle VH includes, for example, the types of various inspections performed on the vehicle VH, the time when the inspections were performed, and records of the replacement of consumable parts such as tires, engine oil, oil filters, and brake pads. The data for failure diagnosis of the vehicle VH is, for example, data acquired through “diagnostic communication”, which uses data transmitted and received by inter-ECU communication conducted over the in-vehicle network via the CAN to diagnose failures.

The controller 21 of the control apparatus 20 analyzes the acquired vehicle data VD to determine whether the vehicle data VD is the first vehicle data VD1 or the second vehicle data VD2.

In step S2, the controller 21 of the control apparatus 20 selects, depending on the type of vehicle data VD determined in step S1, the driver U1 or the owner U2 of the vehicle VH as an authorized party who grants permission to provide the vehicle data VD to a third party other than the driver U1 and the owner U2. Specifically, in a case in which the type of vehicle data VD is the first vehicle data VD1, the controller 21 selects the driver U1 as the authorized party. For example, in a case in which the vehicle data VD is the collision history of the vehicle VH, it can be considered that the driver U1, rather than the owner U2, is involved in the collision of the vehicle VH. Therefore, the controller 21 selects the driver U1 as the authorized party who grants permission to provide the collision history of the vehicle VH to a third party. Alternatively, in a case in which the type of vehicle data VD is the second vehicle data VD2, the controller 21 selects the owner U2 as the authorized party. For example, in a case in which the vehicle data VD is data indicating the maintenance history of the vehicle VH, it can be considered that the owner U2, rather than the driver U1, performs the maintenance. Therefore, the controller 21 selects the owner U2 as the authorized party who grants permission to provide the maintenance history of the vehicle VH to a third party.

As an example, a description is given of a case in which the type of vehicle data VD is the first vehicle data VD1 and the driver U1 is selected as the authorized party in step S2.

In step S3, the controller 21 of the control apparatus 20 notifies the authorized party selected in step S2 of information RD1 prompting for the permission. Specifically, the controller 21 transmits, to the first terminal apparatus 30 via the communication interface 23, information RD1 prompting the driver U1 for the permission, the driver U1 having been selected as the authorized party in step S2.

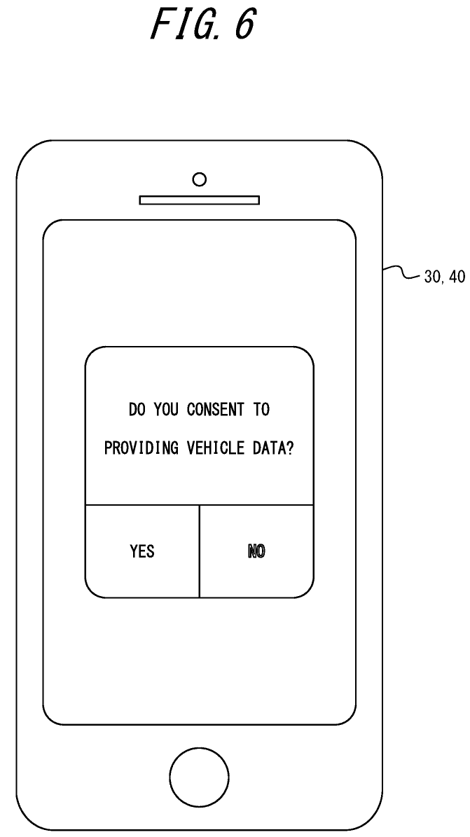

In the present embodiment, the message “DO YOU CONSENT TO PROVIDING VEHICLE DATA?” is transmitted as the information RD1 prompting for the permission. In the example of FIG. 6, the controller 31 of the first terminal apparatus 30 receives the message from the control apparatus 20 via the communication interface 33 and controls the output interface 35, such as a display, to output the received message. In the present embodiment, the controller 31 of the first terminal apparatus 30 controls a display corresponding to the output interface 35 to display the content of the information RD1 prompting for the permission, but the controller 31 may control a speaker corresponding to the output interface 35 to output as audio the content of the information RD1 prompting for the permission.

In the present embodiment, the information RD1 prompting for the permission is transmitted at any timing. For example, the information RD1 prompting for the permission is transmitted per one trip, which starts from when the driver U1 starts the power source, such as the engine or motor of the vehicle VH and ends when the driver U1 stops the power source.

In step S4, in a case in which the operation to grant the permission is performed by the driver U1, the controller 31 of the first terminal apparatus 30 controls the input interface 34 to accept the operation. In the example of FIG. 6, upon the driver U1 touching “YES” displayed on a touchscreen serving as the input interface 34 of the first terminal apparatus 30, the controller 31 of the first terminal apparatus 30 accepts this operation as the operation performed by the driver U1 to grant permission. Instead of touching the touchscreen, the driver U1 may provide audio input through a microphone serving as the input interface 34 of the first terminal apparatus 30. The controller 31 of the first terminal apparatus 30 generates permission data PD1 indicating that the driver U1 has granted permission. The controller 31 of the first terminal apparatus 30 transmits the generated permission data PD1 to the control apparatus 20 via the communication interface 33. On the other hand, in a case in which the operation to grant permission is not performed by the driver U1, the flow of FIG. 5 ends. In the example of FIG. 6, the flow of FIG. 5 ends upon the driver U1 touching “NO” displayed on the touchscreen.

A case in which the type of vehicle data VD is the second vehicle data VD2 and the owner U2 is selected as the authorized party in step S2 is described as another example.

In step S3, the controller 21 of the control apparatus 20 notifies the authorized party selected in step S2 of information RD2 prompting for the permission. Specifically, the controller 21 transmits, to the second terminal apparatus 40 via the communication interface 23, information RD2 prompting the owner U2 for the permission, the owner U2 having been selected as the authorized party in step S2.

In the present embodiment, the message “DO YOU CONSENT TO PROVIDING VEHICLE DATA?” is transmitted as the information RD2 prompting for the permission. In the example of FIG. 6, the controller 41 of the second terminal apparatus 40 receives the message from the control apparatus 20 via the communication interface 43 and controls the output interface 45 such as a display to output the received message. In the present embodiment, the controller 41 of the second terminal apparatus 40 controls a display corresponding to the output interface 45 to display the content of the information RD2 prompting for the permission; however, the controller 41 may control a speaker corresponding to the output interface 45 to output as audio the content of the information RD2 prompting for the permission.

In the present embodiment, the information RD2 prompting for the permission is transmitted at any timing. For example, the information RD2 prompting for the permission is sent when the owner U2 has purchased the vehicle VH.

In step S4, in a case in which the operation to grant permission is performed by the owner U2, the controller 41 of the second terminal apparatus 40 controls the input interface 44 to accept the operation. In the example of FIG. 6, upon the owner U2 touching “YES” displayed on a touchscreen serving as the input interface 44 of the second terminal apparatus 40, the controller 41 of the second terminal apparatus 40 accepts this operation as the operation for the owner U2 to grant permission. Instead of touching the touchscreen, the owner U2 may provide audio input through a microphone serving as the input interface 44 of the second terminal apparatus 40. The controller 41 of the second terminal apparatus 40 generates permission data PD2 indicating that the owner U2 has granted permission. The controller 41 of the second terminal apparatus 40 transmits the generated permission data PD2 to the control apparatus 20 via the communication interface 43. On the other hand, in a case in which the operation to grant permission is not performed by the owner U2, the flow of FIG. 5 ends. In the example of FIG. 6, the flow of FIG. 5 ends upon the owner U2 touching “NO” displayed on the touchscreen.

The controller 21 of the control apparatus 20 performs control to disclose the vehicle data VD to a third party in step S5, in a case in which the operation to grant the permission is performed by the driver U1 via the first terminal apparatus 30 or by the owner U2 via the second terminal apparatus 40 in step S4. Specifically, upon receiving, in step S5, the permission data PD1 transmitted from the first terminal apparatus 30 or the permission data PD2 transmitted from the second terminal apparatus 40 via the communication interface 23, the controller 21 of the control apparatus 20 performs control to disclose the vehicle data VD to a third party. The vehicle data VD may be disclosed to a third party by any appropriate method. For example, the controller 21 of the control apparatus 20 discloses the vehicle data VD to a third party by controlling a web server to publish the vehicle data VD on the Internet. Alternatively, the controller 21 of the control apparatus 20 may disclose the vehicle data VD to a third party by controlling a display serving as the output interface 25 to display the vehicle data VD.

As described above, the controller 21 of the control apparatus 20 selects, depending on the type of vehicle data VD obtained by monitoring a state of the vehicle VH, the driver U1 or the owner U2 of the vehicle VH as an authorized party who grants the permission to provide the vehicle data VD to a third party other than the driver U1 and the owner U2. The controller 21 of the control apparatus 20 notifies the selected authorized party of information prompting for the permission. The controller 21 of the control apparatus 20 performs control to disclose the vehicle data VD to a third party upon an operation to grant the permission being performed by the driver U1 via the first terminal apparatus 30. Alternatively, the controller 21 of the control apparatus 20 performs control to disclose the vehicle data VD to a third party upon an operation to grant the permission being performed by the owner U2 via the second terminal apparatus 40.

According to the present embodiment, in providing vehicle data VD to a third party, permission from the authorized party can be reliably obtained even if the party who has authority to grant permission for provision differs depending on the type of vehicle data VD. As a result, a situation is likely to be avoided in which the person who has permitted the provision of the vehicle data VD is not an authorized party and thus the vehicle data VD cannot be provided. Therefore, the effective use of the vehicle data VD is facilitated.

As a variation of the present embodiment, in the case in which the driver U1 is selected as the authorized party in step S2, the controller 21 of the control apparatus 20 may transmit, in step S3, the information RD1 prompting for the permission to an in-vehicle display apparatus mounted in the vehicle VH instead of transmitting the information RD1 to the first terminal apparatus 30. The in-vehicle display apparatus can communicate with the control apparatus 20. The in-vehicle display apparatus may, for example, be a car navigation device. In the present embodiment, the in-vehicle display apparatus is installed in the dashboard of the vehicle VH. The in-vehicle display apparatus includes a display or a speaker, for example, as an output interface. The in-vehicle display apparatus includes a touchscreen or microphone integrated with the display, for example, as an input interface. The in-vehicle display apparatus accepts input operations from the driver U1 via the input interface.

In the present variation, the operation to grant permission by the driver U1 in step S4 is performed via the in-vehicle display apparatus. In the present variation, the controller 21 of the control apparatus 20 controls the display as the output interface of the in-vehicle display apparatus to display the message “DO YOU CONSENT TO PROVIDING VEHICLE DATA?” transmitted as the information RD prompting for the permission, as in the example illustrated in FIG. 6. The controller 21 may control a speaker serving as the output interface of the in-vehicle display apparatus to output as audio the content of the information RD1 prompting for the permission. The driver U1 performs the operation to grant permission by touching “YES” displayed on the touchscreen serving as the input interface of the in-vehicle display apparatus. Instead of touching the touchscreen, the driver U1 may provide audio input through a microphone serving as the input interface of the in-vehicle display apparatus. In step S3, upon the operation of granting the permission being performed by the driver U1 via the in-vehicle display apparatus, the in-vehicle display apparatus generates the permission data PD1 indicating that the driver U1 has granted the permission. In step S5, upon receiving the permission data PD1 from the in-vehicle display apparatus via the communication interface 23, the controller 21 of the control apparatus 20 performs control to disclose the vehicle data VD to a third party. On the other hand, in the case in which no operation to grant the permission is performed by the driver U1, the flow of FIG. 5 ends. In other words, upon the driver U1 touching “NO” displayed on the touchscreen of the in-vehicle display apparatus, the flow of FIG. 5 ends.

The present variation improves the operability for the driver U1. The present variation also enables to prompt the driver U1 to grant the permission even in the case in which the driver U1 does not have the first terminal apparatus 30. This also makes it easier for the driver U1 to notice the message. Consequently, this makes it easier to obtain the permission from the driver U1, to thereby further facilitate effective use of vehicle data VD.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

For example, in the present embodiment, the information RD1 or RD2 transmitted in step S3 to prompt for the permission may further include information indicating an incentive to be awarded to a party who has granted permission. Specifically, the controller 21 of the control apparatus 20 may transmit, as the information RD1 or RD2 prompting for the permission, a message "DO YOU CONSENT TO PROVIDING VEHICLE DATA? EARN POINTS BY CONSENTING!", via the communication interface 23. The incentive awarded to the party who has granted permission is, for example, points that can be used when the party who has granted permission can use to buy a certain product or to receive certain service, or a coupon that can be used at the destination. The awarding of incentives makes it even easier to obtain permission, to thereby further facilitate effective use of the vehicle data VD.

As a variation of the present embodiment, the controller 21 of the control apparatus 20 may transmit the information RD1 prompting for the permission over a certain unit period, such as per day or per month, instead of per one trip. In this case, as long as an operation to grant permission has been performed by the driver U1 at least once during the unit period, the controller 21 of the control apparatus 20 may perform control to disclose the vehicle data VD to a third party within the unit period without obtaining permission again from the driver U1. This eliminates the need for the driver U1 to perform the operation to grant permission multiple times, and thus the burden on the driver U1 is reduced. This makes it even easier to obtain permission, to thereby further facilitate effective use of the vehicle data VD.

As a variation of the present embodiment, the controller 21 of the control apparatus 20 may transmit the information RD2 prompting for the permission over a certain unit period, such as per day or per month, rather than only when the owner U2 has purchased the vehicle VH. In this case, for example, even if the owner U2 has unintentionally missed the opportunity to perform the operation to grant permission when having purchased the vehicle VH, the owner U2 can grant permission later. In other words, more opportunities to obtain permission from the owner U2 can be provided. This makes it even easier to obtain permission, to thereby further facilitate effective use of the vehicle data VD.

1. A control apparatus comprising a controller configured to:
select, depending on a type of vehicle data obtained by monitoring a state of a vehicle, a driver or an owner of the vehicle as an authorized party who grants permission to provide the vehicle data to a third party other than the driver and the owner; and
notify the selected authorized party of information prompting for the permission.

2. The control apparatus according to claim 1, wherein
the type of vehicle data includes first vehicle data obtained during movement of the vehicle and second vehicle data obtained during a period other than during movement of the vehicle, and
the controller selects, as the authorized party, the driver in a case in which the type of vehicle data is the first vehicle data and the owner in a case in which the type of vehicle data is the second vehicle data.

3. The control apparatus according to claim 2, wherein the first vehicle data includes data indicating a collision history, a usage history, or a travel distance of the vehicle.

4. The control apparatus according to claim 2, wherein the second vehicle data includes data indicating a maintenance history of the vehicle or data for failure diagnosis.

5. The control apparatus according to claim 1, further comprising
a communication interface configured to communicate with a first terminal apparatus used by the driver, wherein
the controller transmits the information prompting for the permission to the first terminal apparatus via the communication interface in a case in which the driver is selected as the authorized party.

6. The control apparatus according to claim 5, wherein the controller performs control to disclose the vehicle data to the third party upon an operation to grant the permission being performed by the driver via the first terminal apparatus.

7. The control apparatus according to claim 1, further comprising
a communication interface configured to communicate with an in-vehicle display apparatus mounted in the vehicle, wherein
the controller transmits the information prompting for the permission to the in-vehicle display apparatus via the communication interface in a case in which the driver is selected as the authorized party.

8. The control apparatus according to claim 7, wherein the controller performs control to disclose the vehicle data to the third party upon an operation to grant the permission being performed by the driver via the in-vehicle display apparatus.

9. The control apparatus according to claim 1, further comprising
a communication interface configured to communicate with a second terminal apparatus used by the owner, wherein
the controller transmits the information prompting for the permission to the second terminal apparatus via the communication interface in a case in which the owner is selected as the authorized party.

10. The control apparatus according to claim 9, wherein the controller performs control to disclose the vehicle data to the third party upon an operation to grant the permission being performed by the owner via the second terminal apparatus.

11. A system comprising:
the control apparatus according to claim 1;
a first terminal apparatus used by the driver and configured to communicate with the control apparatus; and
a second terminal apparatus used by the owner and configured to communicate with the control apparatus.

12. A system comprising:
the control apparatus according to claim 1;
an in-vehicle display apparatus mounted in the vehicle and configured to communicate with the control apparatus; and
a second terminal apparatus used by the owner and configured to communicate with the control apparatus.

13. A vehicle having the control apparatus according to claim 1 mounted therein.

14. A control method comprising:
selecting, by a control apparatus, depending on a type of vehicle data obtained by monitoring a state of a vehicle, a driver or an owner of the vehicle as an authorized party who grants permission to provide the vehicle data to a third party other than the driver and the owner; and
notifying, by the control apparatus, the selected authorized party of information prompting for the permission.

15. The control method according to claim 14, wherein
the type of vehicle data includes first vehicle data obtained during movement of the vehicle and second vehicle data obtained during a period other than during movement of the vehicle, and
the selecting includes selecting, as the authorized party, the driver in a case in which the type of vehicle data is the first vehicle data and the owner in a case in which the type of vehicle data is the second vehicle data.

16. The control method according to claim 15, wherein the first vehicle data includes data indicating a collision history, a usage history, or a travel distance of the vehicle.

17. The control method according to claim 15, wherein the second vehicle data includes data indicating a maintenance history of the vehicle or data for failure diagnosis.

18. The control method according to claim 14, further comprising transmitting, by the control apparatus, the information prompting for the permission to a first terminal apparatus, used by the driver, in a case in which the driver is selected as the authorized party.

19. The control method according to claim 14, further comprising transmitting, by the control apparatus, the information prompting for the permission to an in-vehicle display apparatus, mounted in the vehicle, in a case in which the driver is selected as the authorized party.

20. The control method according to claim 14, further comprising transmitting, by the control apparatus, the information prompting for the permission to a second terminal apparatus, used by the owner, in a case in which the owner is selected as the authorized party.
